(19) United States
(12) Patent Application Publication
(10) Pub. No.: US 2002/0100814 A1
(43) Pub. Date: Aug. 1, 2002

(54) Method and means for controlling the functions of an irrigation system and ancillary equipment

(76) Inventors: Ron Pollak, Elkhorn, NE (US); Marv Schulz, Omaha, NE (US); Craig Malsam, Omaha, NE (US); Dave Mack, Omaha, NE (US)

Correspondence Address: DENNIS L. THOMTE, ZARLEY, McKEE, VOORHEES $ SEASE, SUITE 1111, 2120 SOUTH 72ND STREET,, OMAHA,, NE, 68124, US

(21) Appl. No.: 09/774,503

(22) Filed: Jan. 31, 2001

(51) Int. Cl. A01G 25/00; B05B 12/08

(52) U.S. Cl. 239/63; 239/69; 239/71

(57) ABSTRACT

A method and means for automatically monitoring and controlling the functions of an irrigation system and ancillary equipment is disclosed herein. A computer is provided which has a Real Time Operating System for monitoring and controlling all irrigation components. The RTOS is in communication with a moisture sensor and/or a weather station. The RTOS continuously monitors soil moisture and weather data and automatically turns on irrigation equipment based on user-defined soil moisture and water needs. The RTOS is provided with a plant disease model and will automatically turn on a chemigation system is plant disease conditions are present.

### BACKGROUND OF THE INVENTION

1. Field of the I nvention

This invention relates to a method and means for controlling the functions of an irrigation system and ancillary equipment and more particularly to a computerized method and means for controlling the functions of irrigation systems and the equipment associated therewith utilizing a Real Time Operating System (RTOS).

2. Description of the Related Art

Existing mechanized irrigation systems and components are independently controlled whereby each component is turned on or off, or adjusted manually based on the operating conditions of another mechanized irrigation component. Conventional prior art irrigation systems require manual monitoring and intervention by an operator. For example, if the operator determines that the soil moisture is such that irrigation is required, the operator must then turn on the water valve, the water pump, and the irrigation system. The operator permits the system to operate until the operator determines that the soil moisture is adequate, at which time the operator turns off the water valve, the water pump, and the irrigation system. Further, in some cases, the operator will determine that conditions are present for possible plant disease and, if so, will turn on the irrigation/chemigation equipment to treat the plant disease. When the crop has been treated for plant disease, the operator will turn off the irrigation/chemigation equipment. The manual monitoring of soil moisture, weather conditions, etc., and the manual control of the irrigation, chemigation, and equipment ancillary thereto are labor intensive and time-consuming.

### SUMMARY OF THE INVENTION

The instant invention consists of a software program operating in real time or a Real Time Operating System (RTOS) which continually monitors one or more soil moisture sensors and/or a weather station and which controls the operation of an irrigation system and equipment ancillary thereto. The connection between the RTOS and the moisture sensors and/or weather station may be a hard-wired connection or by way of conventional wireless technology. The RTOS includes user-defined soil moisture, water need, and plant disease models. The RTOS will automatically turn on the irrigation system and/or chemigation system based on soil moisture, water needs and plant disease models. The RTOS will also turn on other equipment of the system such as valves, pumps, etc., based on the requirements of the irrigation system.

It is therefore a principal object of the invention to a provide method and means for controlling the functions of an irrigation and/or chemigation system and ancillary equipment through the use of a software program which operates in real time (Real Time Operating System).

Another object of the invention is to provide a method and means for automatically monitoring and controlling the functions of an irrigation system which eliminates the need for any human intervention.

Still another object of the invention is to provide a method and means for monitoring and controlling the functions of an irrigation system which utilizes a userdefined set of dependencies to control the interaction between the irrigation equipment, pumps, pressure sensors, engine generators, etc.

Still another object of the invention is to provide a method and means for monitoring and controlling the functions of an irrigation system and ancillary equipment wherein an RTOS is utilized which provides a “closed-loop” operating system whereby the need for irrigation/chemigation is determined, and irrigation/chemigation equipment controlled, in an automatic fashion.

Yet another object of the invention is to provide a method and means for controlling the functions of an irrigation system and ancillary equipment thereto which utilizes data from weather station sensors, and/or soil moisture sensors.

These and other objects will be apparent to those skilled in the art.

### BRIEF DESCRIPTION OF THE DRAWINGS

FIG. 1 is a schematic drawing illustrating the means for controlling the functions of an irrigation system and ancillary equipment.

### DESCRIPTION OF THE PREFERRED EMBODIMENT

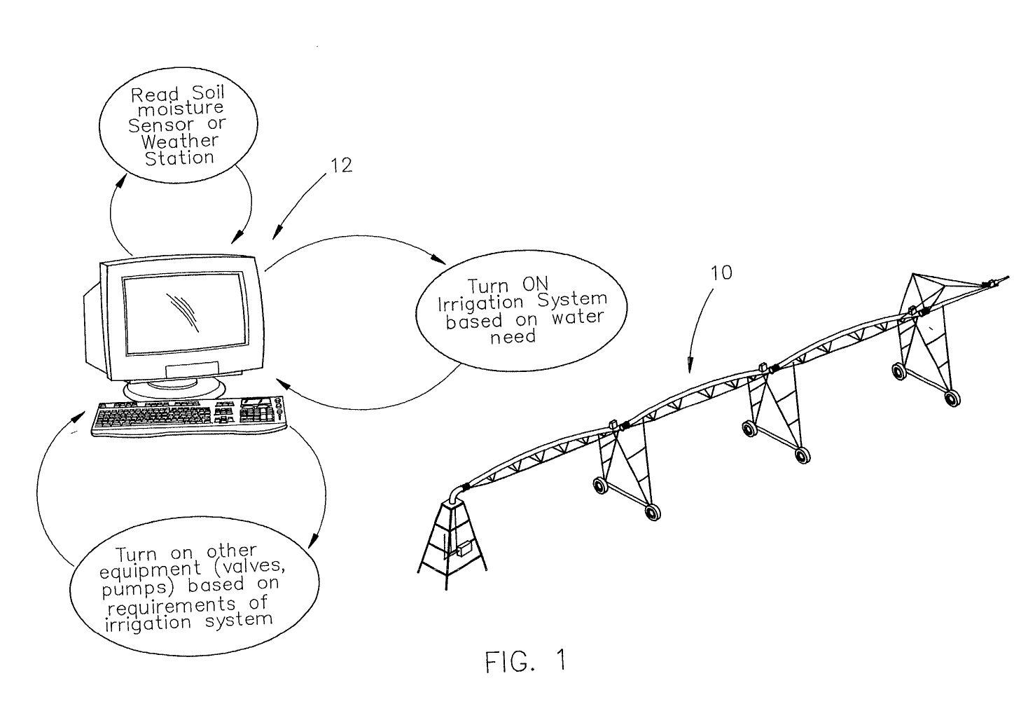

In FIG. 1, the numeral 10 refers to a conventional center pivot irrigation system. Irrigation system 10 may include a conventional chemigation system for applying chemicals to the crop growing in the field. System 10 normally includes ancillary equipment such as conventional pumps, valves, pressure sensors, engine generators, etc. Although a center pivot irrigation system is illustrated, the invention to be described herein is not limited to a center pivot irrigation system but will also be applicable to linear irrigation systems, drip irrigation systems, and other types of irrigation systems.

The numeral 12 refers to a computer which may be either hard-wired to the control components of the irrigation system or which may be connected thereto through conventional wireless technology. Computer 12 includes a software program which operates in real time, commonly referred to as a Real Time Operating System (RTOS), for monitoring soil moisture and weather conditions and to control all components or equipment of the irrigation system such as valves, pumps, pressure sensors, engine generators, etc. The RTOS provides a “closed loop” operating system without the need for any human intervention. As seen in FIG. 1, the RTOS has the capability to read data from one or more soil moisture sensors located in the field to be irrigated and/or reading data from a conventional weather station. The soil moisture sensor is preferably located in the field to be irrigated although the sensor does not have to be in the field to be irrigated. The moisture sensor may be used as a relative measurement only. For example, if the soil moisture sensor is in field A, which is twice as wet as field B, the soil moisture sensor reading can be used to control the irrigation of field B because of the relative measure. If a weather station is used, it does not have to be in the field to be irrigated, but should be in the proximity of the field or in a location with weather similar to the irrigated field. The weather station then calculates the soil moisture based on evaporation, irrigation, rainfall, and water used by the plants. A weather station can also collect data relating to conditions which may be present for plant disease. The soil moisture sensor and weather station are either hard-wired to the computer 12 or will be in communication therewith by conventional wireless technology. Computer 12, through the software program therein, continuously monitors the moisture sensor and/or weather station and automatically communicates with the control components of the irrigation system to activate the irrigation system based on userdefined water needs. The computer RTOS also has the ability to turn on other equipment such as valves, pumps, etc., based on requirements of the irrigation system. The RTOS also has the ability to turn on chemigation equipment associated with the irrigation system should plant disease conditions be present, based on plant disease models in the software.

In summary, the RTOS utilizes a user-defined set of dependencies to control the interaction between irrigation equipment, chemigation equipment, pumps, pressure sensors, engine generators, valves, etc. The RTOS automatically monitors the soil moisture sensor or sensors and/or weather station data and determines the irrigation scheduling requirements. The RTOS determines that the irrigation of the field is required based on the user-defined soil moisture and water needs. The RTOS will automatically turn on other equipment required by the irrigation system. If the prescribed irrigation requirement has been met, the RTOS automatically turns off the irrigation system and will then continue to continuously monitor soil moisture and weather information to again actuate the irrigation system and assess further water needs as determined by the soil moisture sensors, weather station data, and userdefined soil moisture and water needs in the RTOS.

Thus it can be seen that a method and means for automatically controlling the functions of an irrigation system and ancillary equipment has been described which achieves at least all of its stated objectives.

We claim:

1. In combination:
an irrigation system, including components thereof, for irrigating a field;
a computer including a Real Time Operating System (RTOS);
at least one soil moisture sensor;
said RTOS being operatively connected to said irrigation system for controlling the operation thereof;
said RTOS being operatively connected to said soil moisture sensor where by said RTOS may monitor soil moisture conditions and control said irrigation system in response thereto.

2. The combination of claim 1 wherein said RTOS is connected to a weather station which provides weather data to said RTOS.

3. The combination of claim 1 wherein said RTOS includes user-defined soil moisture needs.

4. The combination of claim 2 wherein said RTOS includes user-defined water needs.

5. The combination of claim 2 wherein said RTOS includes a user-defined plant disease model.

6. The combination of claim 1 wherein said RTOS is connected to equipment associated with said irrigation system for controlling the operation thereof based on the requirements of said irrigation system.

7. The combination of claim 2 wherein said RTOS is connected to equipment associated with said irrigation system for controlling the operation thereof based on the requirements of said irrigation system.

8. In combination:
an irrigation system, including components thereof, for irrigating a field;
a computer including a Real Time Operating System (RTOS);
said RTOS being operatively connected to said irrigation system for controlling the operation thereof;
said RTOS being in communication with a weather station whereby said RTOS may monitor weather data communicated by said weather station and control said irrigation system in response thereto.

9. The combination of claim 8 wherein said RTOS includes user-defined water needs.

10.The combination of claim 8 wherein said RTOS includes a user-defined plant disease model.

11. The combination of claim 8 wherein said RTOS is connected to equipment associated with said irrigation system for controlling the operation thereof based on the requirements of said irrigation system.

12.The combination of claim 8 wherein said RTOS is connected to at least one soil moisture sensor.

13.The combination of claim 1 wherein said soil moisture sensor is hard-wired connected to said RTOS.

14.The combination of claim 1 wherein said moisture sensor is connected to said RTOS by wireless communication.

15.The combination of claim 8 wherein said weather station is in communication with said RTOS by wireless communication.

16.The method of automatically controlling the operation of an irrigation system for irrigating a field, comprising the steps of:
providing a computer having a Real Time Operating System (RTOS) for monitoring and controlling the operation of the irrigation system;
providing at least one soil moisture sensor;
operatively connecting said RTOS to the said soil moisture sensor whereby said soil moisture sensor will communicate soil moisture data to said RTOS;
said RTOS automatically controlling the operation of the irrigation system based upon the communicated data from the soil moisture sensor.

17.The method of claim 16 wherein said RTOS controls the operation of the irrigation system based upon user-defined soil moisture and water needs.

18.The method of claim 16 including the further step of providing weather data from a weather station to said RTOS.

19.The method of claim 17 including the further step of providing weather information from a weather station to said RTOS.

20.The method of automatically controlling the operation of an irrigation system for irrigating a field, comprising the steps of:
providing a computer having a Real Time Operating System (RTOS) for monitoring and
controlling the operation of the irrigation system;
providing at least one weather station;
operatively connecting said RTOS to said weather station whereby said weather station will communicate weather data to said RTOS;
said RTOS automatically controlling the operation of the irrigation system based upon the communicated data from the said weather station.

21.The method of claim 20 further including the step of programming a plant disease model in said RTOS.
